(19) United States
(12) Patent Application Publication
(10) Pub. No.: US 2025/0211023 A1
(43) Pub. Date: Jun. 26, 2025

(54) INTELLIGENT POWER DISTRIBUTION MANAGEMENT SYSTEM

(71) Applicant: TOWA Industries Inc., Campbell, CA (US)

(72) Inventors: Richard K. Ogawa, SR., Campbell, CA (US); Ronald L. Silorio, Campbell, CA (US); James George Hanlon, Campbell, CA (US)

(21) Appl. No.: 19/077,457

(22) Filed: Mar. 12, 2025

Related U.S. Application Data
(63) Continuation-in-part of application No. 17/876,949, filed on Jul. 29, 2022.
(60) Provisional application No. 63/654,648, filed on May 31, 2024.
(60) Provisional application No. 63/666,759, filed on Jul. 2, 2024.
(60) Provisional application No. 63/673,700, filed on Jul. 20, 2024.
(60) Provisional application No. 63/673,702, filed on Jul. 20, 2024.
(60) Provisional application No. 63/747,747, filed on Jan. 21, 2025.

(51) Int. Cl. H02J 13/00; H02J 3/00

(52) U.S. Cl. CPC H02J 13/0005; H02J 3/0012; H02J 13/00002; H02J 13/00036; H02J 2310/60

(57) ABSTRACT

A power distribution management system dynamically manages power from an inverter to ensure uninterrupted supply to critical devices, such as power tools, while selectively controlling power to interruptible devices, such as battery chargers, to maintain total current below a predefined threshold. The system includes a microcontroller, an analog-to-digital converter for precise current measurement, and a powerline communications module for real-time data exchange. Current transformers monitor power to each connected device, enabling the system to identify and disconnect lower-priority loads, such as battery chargers, during high-demand periods, while ensuring essential tools remain powered. The system automatically restores power to disconnected devices when load conditions allow, optimizing efficiency and preventing overloading. This intelligent power management approach is particularly suited for portable or hybrid power systems in industrial and field applications.

### CROSS-REFERENCE TO RELATED APPLICATIONS

This application claims priority to co-pending United States Provisional Patent Applications Ser. Nos. 63/654,648, filed on May 31, 2024; 63/666,759, filed Jul. 2, 2024; 63/673,700, filed on Jul. 20, 2024; 63/673,702, filed on Jul. 20, 2024; and 63/747,747 filed on Jan. 21, 2025, and the disclosures of each thereof are hereby incorporated by reference in their entirety. This application is also a continuation-in-part to co-pending U.S. patent application Ser. No. 17/876,949, filed on Jul. 29, 2022 and the disclosure thereof is also hereby incorporated by reference in its entirety.

### TECHNICAL FIELD OF THE DISCLOSURE

This application relates generally to power distribution management. The application relates more specifically to power distribution management designed to provide power simultaneously to demand based devices and power controlled outlets to keep total power consumption below a selected threshold value.

### BACKGROUND OF THE DISCLOSURE

Multi-socket power extension sources, sometimes referred to as power strips, provide multiple outlets for appliances, tools, and equipment, powered by a single power source, such as a wall outlet, generator, or battery pack. The power source is commonly regulated by a circuit breaker or other overcurrent component, which disconnects the power source when a current limit is exceeded. The appliances, tools, and equipment plugged into the multi-socket power extension source may draw current that fluctuates with use. The current may occasionally exceed the current limit of the overcurrent component, causing the power source to be disconnected. Disconnection may interrupt usage of the appliances, tools, and equipment, and may require resetting the overcurrent component.

### SUMMARY OF THE DISCLOSURE

This disclosure describes a power distribution management system that dynamically allocates power to connected devices while maintaining overall circuit safety and efficiency. The system includes a first set of power outlets designated for critical devices, such as tools requiring uninterrupted operation, and a second set of power outlets designated for non-critical devices, such as battery chargers. A circuit power monitor tracks the total power usage of the system, while outlet power monitors provide detailed power data for individual outlets in the second set. A controller selectively disables power to one or more outlets in the second set when the total power usage reaches a predefined threshold, ensuring continued operation of critical devices.

Each outlet may include a selector switch allowing it to be assigned to either the first or second set of outlets, providing flexibility in configuration. The circuit and outlet power monitors may include current transformers to measure power consumption. The controller can also re-enable power to disconnected outlets in the second set when the total power usage drops below the threshold, with priority given based on the power usage prior to disconnection.

A method for managing power distribution is also provided, which involves monitoring current draw from an inverter, prioritizing power delivery to critical devices, and selectively disconnecting non-critical devices when a threshold is exceeded. Power to non-critical devices is restored once the total current falls below the threshold. This method incorporates components such as current transformers, analog-to-digital converters, and powerline communication modules for real-time coordination and data exchange. Additionally, historical power usage data may be stored and analyzed for optimizing load management.

A computer program product is further described, containing instructions for implementing the system's functionality. These instructions enable monitoring power usage, prioritizing critical devices, and selectively disconnecting or reconnecting non-critical devices. The program also supports features like generating real-time alerts and transmitting data for effective power distribution management. This comprehensive system and method are particularly suited for scenarios requiring efficient and reliable power allocation across multiple devices.

One non-limiting object of the disclosure is the provision of a power distribution management system that dynamically allocates power to connected devices while maintaining overall circuit safety and efficiency.

In another and/or alternative non-limiting object of the disclosure is the provision of a power distribution management system that includes a first set of power outlets designated for critical devices, and a second set of power outlets designated for non-critical devices.

In another and/or alternative non-limiting object of the disclosure is the provision of a power distribution management system that includes a circuit power monitor that tracks the total power usage of the system, while outlet power monitors provide detailed power data for individual outlets in the second set.

In another and/or alternative non-limiting object of the disclosure is the provision of a power distribution management system that includes that includes a controller that selectively disables power to one or more outlets in the second set when the total power usage reaches a predefined threshold, ensuring continued operation of critical devices.

In another and/or alternative non-limiting object of the disclosure is the provision of a power distribution management system that includes a selector switch that allows the switch to be assigned to either the first or second set of outlets.

In another and/or alternative non-limiting object of the disclosure is the provision of a power distribution management system that includes current transformers to measure power consumption.

In another and/or alternative non-limiting object of the disclosure is the provision of a power distribution management system that includes a controller that can re-enable power to disconnected outlets in the second set when the total power usage drops below a predefined threshold current, with priority of re-enabled power can optionally be given based on the power usage prior to disconnection.

In another and/or alternative non-limiting object of the disclosure is the provision of a method for managing power distribution which involves monitoring current draw from an inverter, prioritizing power delivery to critical devices, and selectively disconnecting non-critical devices when a threshold is exceeded.

In another and/or alternative non-limiting object of the disclosure is the provision of a method for managing power distribution wherein power to non-critical devices can be restored once the total current falls below a predefined threshold current.

In another and/or alternative non-limiting object of the disclosure is the provision of a method for managing power distribution wherein historical power usage data can be stored and analyzed for optimizing load management.

In another and/or alternative non-limiting object of the disclosure is the provision of a computer program product containing instructions for implementing the system's functionality such as monitoring power usage, prioritizing critical devices, and selectively disconnecting or reconnecting non-critical devices, and wherein the program optionally supports features like generating real-time alerts and transmitting data for effective power distribution management.

In another and/or alternative non-limiting object of the disclosure is the provision of a power distribution management system comprising a) a first set of one or more power outlets on a power distribution circuit, the power distribution circuit including a circuit power monitor configured to monitor power used by the circuit; b) a second set of one or more power outlets on the power distribution circuit wherein each circuit of the second set includes an associated outlet power monitor configured to monitor power to an associated power outlet; and c) a controller configured to selectively disable power to one or more power outlets in the second set when power monitored by the circuit power monitor achieves a threshold value.

In another and/or alternative non-limiting object of the disclosure is the provision of a power distribution management system wherein each outlet includes a selector switch designating its associated outlet as being in the first set or second set of power outlets.

In another and/or alternative non-limiting object of the disclosure is the provision of a power distribution management system wherein one or more of the circuit power monitor and the outlet power monitor is comprised of a current transformer.

In another and/or alternative non-limiting object of the disclosure is the provision of a power distribution management system wherein one or more devices powered by the first set of power outlets comprise critical devices.

In another and/or alternative non-limiting object of the disclosure is the provision of a power distribution management system wherein the one or more devices powered by the second set of power outlets comprise battery chargers.

In another and/or alternative non-limiting object of the disclosure is the provision of a power distribution management system wherein the controller is further configured to selectively enable power to the one or more power outlets in the second set of power outlets when the power monitored by the circuit power monitor falls below the threshold value.

In another and/or alternative non-limiting object of the disclosure is the provision of a power distribution management system wherein the controller is further configured to selectively enable power to the one more power outlets in the second set based on associated amount of power used prior to disabling.

In another and/or alternative non-limiting object of the disclosure is the provision of a method for managing power distribution, comprising: a) supplying power from an inverter to a plurality of connected devices; b) measuring current to each device using a plurality of current transformers; c) monitoring total current draw using a microcontroller; d) prioritizing power delivery to critical devices; and e) selectively disconnecting non-critical devices when the total current exceeds a predefined threshold.

In another and/or alternative non-limiting object of the disclosure is the provision of a method for managing power distribution further comprising reconnecting non-critical devices when the total current drops below the predefined threshold.

In another and/or alternative non-limiting object of the disclosure is the provision of a method for managing power distribution wherein measuring current comprises using an analog-to-digital converter to convert analog signals from the current transformers into digital data.

In another and/or alternative non-limiting object of the disclosure is the provision of a method for managing power distribution further comprising transmitting and receiving data over a powerline communications module to coordinate power distribution.

In another and/or alternative non-limiting object of the disclosure is the provision of a method for managing power distribution wherein prioritizing power delivery involves identifying critical devices that require continuous operation and non-critical devices that can tolerate interruptions.

In another and/or alternative non-limiting object of the disclosure is the provision of a method for managing power distribution further comprising analyzing power usage data stored by the microcontroller to optimize load management.

In another and/or alternative non-limiting object of the disclosure is the provision of a method for managing power distribution wherein selectively disconnecting non-critical devices includes using controllable switches coupled to the current transformers.

In another and/or alternative non-limiting object of the disclosure is the provision of a computer program product for managing power distribution, comprising non-transitory computer-readable instructions that, when executed by a processor, cause the processor to: a) receive current measurements from a plurality of current transformers; b) calculate total current draw; d) compare the total current draw to a predefined threshold; and e) selectively disconnect or reconnect devices based on the comparison.

In another and/or alternative non-limiting object of the disclosure is the provision of a computer program product for managing power distribution wherein the instructions further cause the processor to prioritize power delivery to critical devices and limit power to non-critical devices.

In another and/or alternative non-limiting object of the disclosure is the provision of a computer program product for managing power distribution wherein the instructions include transmitting and receiving power management data over a powerline communications module.

In another and/or alternative non-limiting object of the disclosure is the provision of a computer program product for managing power distribution wherein the instructions further cause the processor to store historical power usage data for later analysis.

In another and/or alternative non-limiting object of the disclosure is the provision of a computer program product for managing power distribution wherein the instructions include generating real-time alerts when the total current draw approaches the predefined threshold.

In another and/or alternative non-limiting object of the disclosure is the provision of a computer program product for managing power distribution wherein the instructions configure controllable switches to disconnect or reconnect specific devices based on the calculated current draw.

These and other advantages will become apparent to those skilled in the art upon the reading and following of this description.

### BRIEF DESCRIPTION OF THE DRAWINGS

Non-limiting and non-exhaustive embodiments are described with reference to the following drawings, wherein like labels refer to like parts throughout the various views unless otherwise specified. The sizes and relative positions of elements in the drawings are not necessarily drawn to scale. For example, the shapes of various elements are selected, enlarged, and positioned to improve drawing legibility. The particular shapes of the elements as drawn have been selected for ease of recognition in the drawings. Reference may now be made to the drawings, which illustrate various embodiments that the disclosure may take in physical form and in certain parts and arrangement of parts wherein:

FIG. 1 is a flowchart of an example embodiment of a power distribution management system for supplying on-demand devices;

FIG. 2 is an example embodiment of a power distribution management system that functions to provide power to corded tools while concurrently providing power to battery chargers;

FIG. 3 is a circuit diagram for an example embodiment of a power distribution management system that functions to selectively provide power to either power tools or battery chargers; and

FIG. 4 is an example embodiment of a power distribution management system controller.

### DETAILED DESCRIPTION OF THE DISCLOSURE

A more complete understanding of the articles/devices, processes and components disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

As used in the specification and in the claims, the term “comprising” may include the embodiments “consisting of” and “consisting essentially of” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of the enumerated ingredients/steps, which allows the presence of only the named ingredients/steps, along with any unavoidable impurities that might result therefrom, and excludes other ingredients/steps.

Numerical values in the specification and claims of this application should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 inches to 10 inches” is inclusive of the endpoints, 2 inches and 10 inches, and all the intermediate values).

The terms “about” and “approximately” can be used to include any numerical value that can vary without changing the basic function of that value. When used with a range, “about” and “approximately” also disclose the range defined by the absolute values of the two endpoints, e g. “about 2 to about 4” also discloses the range “from 2 to 4.” Generally, the terms “about” and “approximately” may refer to plus or minus 10% of the indicated number.

Various non-limiting embodiments of the present disclosure will now be described to provide an overall understanding of the principles of the structure, function, and use of the apparatus, systems and methods disclosed. Those of ordinary skill in the art will understand that apparatus, systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure. Any failure to specifically describe a combination or sub-combination of components should not be understood as an indication that any combination or sub-combination is not possible.

It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Some portions of the detailed description herein are presented in terms of algorithms and symbolic representations of operations on data bits performed by conventional computer components, including a central processing unit (CPU), memory storage devices for the CPU, and connected display devices. These algorithmic descriptions and representations are the means used by those skilled in the data processing arts to most effectively convey the substance of their work to others skilled in the art. An algorithm is generally perceived as a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that all of these and similar terms are to be associated with the appropriate physical quantities and are merely convenient labels applied to these quantities. Unless specifically stated otherwise, as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The exemplary embodiment also relates to an apparatus for performing the operations discussed herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the methods described herein. The structure for a variety of these systems is apparent from the description above. In addition, the exemplary embodiment is not described with reference to any particular programming language. It will be appreciated that a variety of programming languages may be used to implement the teachings of the exemplary embodiment as described herein.

A machine-readable medium includes any mechanism for storing or transmitting information in a form readable by a machine (e.g., a computer). For instance, a machine-readable medium includes read only memory (“ROM”); random access memory (“RAM”); magnetic disk storage media; optical storage media; flash memory devices; and electrical, optical, acoustical or other form of propagated signals (e.g., carrier waves, infrared signals, digital signals, etc.), just to mention a few examples.

The methods illustrated throughout the specification, may be implemented in a computer program product that may be executed on a computer. The computer program product may comprise a non-transitory computer-readable recording medium on which a control program is recorded, such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

Certain power management situations include on-demand devices, such as appliances or power tools, along with deferred use devices, such as battery chargers, which are fed by a shared power circuit. While power may be interrupted for deferred use devices, on-demand devices may require continuous power access. The shared power circuit has a power supplying capacity threshold. This threshold may be associated with a fuse or circuit breaker for the shared circuit. A threshold may also be associated with a maximum power output by a generator, such as a gasoline or diesel generator that provides AC power to devices via an inverter.

A smart power strip includes multiple power outlets, each controlled by an individual switch and managed by a central controller. The controller repeatedly measures or estimates the total current passing through the strip, comparing it against a prescribed threshold that is set below the rating of an upstream breaker or fuse. If the total current exceeds that threshold, the controller identifies which outlet caused the surge and selectively turns off only that one outlet, avoiding a full power shutdown of all devices. The outlet is automatically reconnected when conditions allow (for example, after the load decreases or after a timed delay). The concept can also be expanded by chaining several Smart Power Strips together in a “primary-secondary-tertiary” arrangement, in which the primary strip coordinates overall current management across all connected strips. This approach prevents overloads at the system level while maintaining power to as many outlets as possible.

An example embodiment herein features a smart circuit breaker installed within an electrical panel that continually measures current flowing through its protected circuit. As it operates, the breaker transmits real-time data about the present current draw, such as “14 amps out of a 20-amp circuit,” to a separate Power Distribution Module (PDM). This live data feed may be delivered through a wired connection, a wireless protocol, or a powerline communication channel. By broadcasting the measured current in near real time, the breaker gives the PDM a highly accurate view of how much headroom remains before the breaker's trip point is reached.

In other example embodiments, the smart breaker also provides updates on its actual trip threshold. This threshold may be fixed (for example, a nominal 20-amp limit) or may be adjustable under certain conditions, such as a demand-response program. If the breaker's trip setting is modified (e.g., lowered to 16 amps during peak utility load periods), the breaker notifies the PDM of the updated trip current. With this information, the PDM can account for the reduced capacity and avoid drawing more current than the circuit can support. Conversely, if the breaker reverts to a higher trip setting, the PDM can detect that additional current capacity is again available.

Upon receiving the ongoing current readings and any updated trip-current information from the breaker, the PDM analyzes whether its own attached loads, such as outlets powering tools, appliances, or other devices, can be safely maintained without causing an overload. If the PDM's load management algorithm determines that one or more connected outlets are pushing the circuit near or above the trip threshold, it selectively disconnects or staggers the activation of those outlets to prevent a nuisance trip. This selective shutdown occurs on a per-outlet basis, enabling only the necessary subload to be turned off while other outlets remain active.

When the overall current draw dips, for instance because a different load on the same breaker has turned off, the breaker's real-time measurements let the PDM know there is now additional current headroom. In response, the PDM can then automatically re-energize previously shed devices or power up new loads. Such continuous communication between the breaker and the PDM provides a dynamic feedback loop that maximizes available current usage while respecting protective limits. This arrangement thus enhances overcurrent protection, reduces the likelihood of full breaker trips, and gives users a more efficient and automated approach to managing electrical loads.

Example embodiments herein prioritize delivery of power to critical devices over non-critical devices, such as battery chargers. Examples of critical devices that professionals may use in the field include:

Power Tools: Drills, saws, grinders, nail guns, and other electric tools that are actively being used for construction, repair, or landscaping tasks.

Power Tools: Saws, drills, sanders, blowers, grinders, air compressors or nail guns.

Medical Equipment: Portable medical devices such as ventilators, defibrillators, or diagnostic tools required in emergency or remote healthcare situations.

Communication Devices: Radios, satellite phones, or portable routers essential for maintaining communication in remote locations or during emergencies.

Lighting Systems: Portable work lights, floodlights, or safety lighting that ensure visibility and safety in dark or low-light conditions.

Pumps: Water pumps or dewatering equipment used in landscaping, construction, or disaster response scenarios.

Measuring and Surveying Equipment: Devices such as laser levels, total stations, or GPS systems used for precision tasks in construction or surveying.

Welding Equipment: Portable welders or soldering devices necessary for on-site fabrication or repair work.

Cutting Equipment: Electric or battery-powered chainsaws, hedge trimmers, or pruning tools commonly used by landscapers or arborists.

Portable Refrigeration Units: Cooling systems for storing temperature-sensitive materials, such as food or medical supplies, during field operations.

Safety Systems: Fans or air circulation devices to ensure safe working conditions in confined or hazardous spaces.

Portable Computers: Laptop computers, tablets, smart phones, etc.

These critical devices typically have higher priority because their operation directly impacts productivity, safety, or the ability to complete tasks in the field effectively.

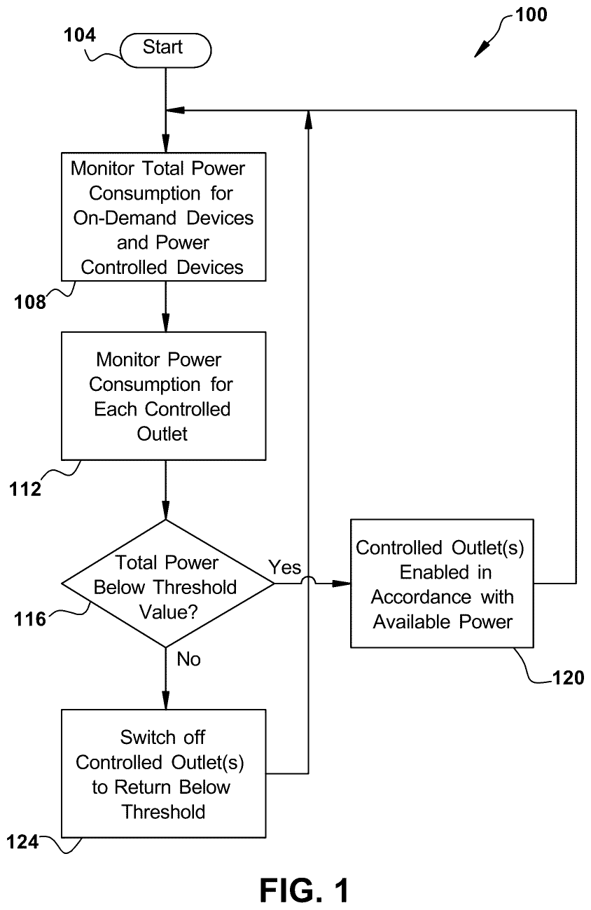

FIG. 1 illustrates a flowchart 100 of an example embodiment of a PDM system for supplying on-demand devices, such as corded power tools, and deferred demand devices, such as battery chargers. The system commences at block 104 and proceeds to block 108 where a total power consumption for on-demand devices and power controlled devices is monitored. Next, power consumption is monitored for each controlled outlet at block 112. A test is made at block 116 to determine whether total power consumed is below a threshold value. If so, all controlled outlets are enabled at block 120 and the system returns to block 108. If the total power is above the threshold, one or more controlled power outlets are turned off to return total power below the threshold value at block 124 before returning to block 108.

In the example embodiment of FIG. 1, a determination as to which outlet, or outlets, are switched off is suitably made based on a difference between the threshold value and current power consumption as compared to power drawn by individual devices. One or more devices are switched off to take the total load below the threshold value. This decision may simply be a “best fit” option. A decision may also be made on interrupting the fewest devices to accomplish the required current draw reduction. Other options are suitably used to determine which outlets are to be switched off:

Greatest Recent Surge (Actively Running Vs. Charging)
Example: A landscaper has a high-power electric hedge trimmer plugged in and running. Meanwhile, two cordless tool chargers (for a leaf blower and a chainsaw) are also connected. When the landscaper kicks on a shop vacuum to clean up clippings, the total current draw spikes above the threshold.
Decision: The system identifies that the vacuum caused the sharpest surge in current. However, the vacuum is actively needed for immediate cleanup, whereas the chargers are only replenishing batteries. The PDM switches off one or both chargers, freeing up enough current capacity so the hedge trimmer and the vacuum can run simultaneously without tripping the breaker.
Outcome: The trimmer and vacuum remain powered (both in active use), while the chargers pause briefly. Once the vacuum finishes, the system detects lower load and automatically re-energizes the chargers.
   Priority-Based Shutoff (Active Work Vs. Idle Charging)
Example: A landscaping team uses several battery-powered tools, hedge trimmers, leaf blowers, weed whackers, that each have dedicated chargers. The same smart power strip also has an outlet powering a portable air compressor for inflating tires and a second outlet powering lights. The user tags the lights and compressor as “High Priority” (vital for safety and mobility) while ranking chargers as “Low Priority.”
Decision: If total current surges (e.g., the air compressor cycles on while the lights are illuminated), the system first looks at lower-priority devices, in this case, the tool chargers. It turns off one or more chargers to ensure the lights remain on and the compressor can run.
Outcome: Essential functions (lighting and air compressor) stay up and running. The chargers simply resume once the compressor shuts off or the total current falls back below the threshold.
   Load Shedding by Detecting Active Vs. Passive Tools
Example: Multiple cordless blowers and trimmers are on charge, but only one is actively being used. The user decides to also power an electric chainsaw from the strip. The chainsaw's motor surges the current draw well above the limit.
Decision: The system detects that several tools are simply charging and have no immediate usage. In contrast, the chainsaw is actively running (high priority). It shuts off some or all of the charging tools, particularly any that are near a full charge, to instantly drop below the threshold.
Outcome: The chainsaw continues to operate seamlessly. Once the operator finishes cutting, the system sees a lower overall load and restarts the chargers automatically.
   User-Defined Scheduling (High-Draw Vs. Low-Draw Landscaping Equipment)
Example: The landscaper has a small electric stump grinder and a battery charger for a heavy-duty hedge trimmer. Both can draw significant current. The smart power strip is configured so that the stump grinder (a major load) only runs alone, while all chargers wait until the grinder is switched off or ramps down.
Decision: If the user tries to run the stump grinder while the hedge trimmer charger is actively pulling a high charge current, the system senses an overload risk. It either delays the charger or shuts it off until the grinder's load stabilizes.
Outcome: The stump grinder operates uninterrupted, avoiding a circuit trip. The hedge trimmer resumes charging immediately after the grinder no longer needs peak power.

### Adaptive Monitoring for Intermittent High-Power Tools

Example: A landscaper connects multiple battery chargers and occasionally uses a high-wattage pressure washer to clean off mowers or vehicles. The washer draws large current surges when triggered.
Decision: Once the washer's trigger is pulled, the smart strip detects a sudden spike that could exceed the threshold. Recognizing that the washer is in active use (i.e., a high priority), it automatically shuts down the chargers for the cordless mowers or trimmers.
Outcome: The pressure washer continues uninterrupted during active cleaning, ensuring it does not trip the breaker. Once the user releases the washer's trigger or finishes cleaning, the system sees the current drop and reactivates the chargers so the landscaping tools can resume charging.

In each scenario, the PDM logic prioritizes tools in immediate use, such as a trimmer, pressure washer, or hedge cutter, while temporarily deactivating lower-priority chargers or devices that can wait. This ensures continuous workflow for the operator and prevents breaker trips that would halt all devices at once.

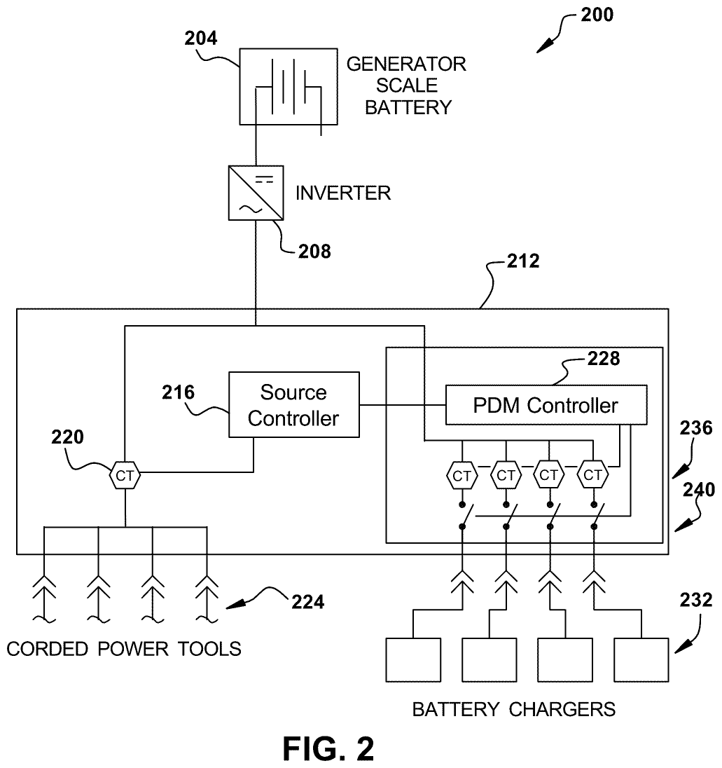

FIG. 2 illustrates a circuit diagram 200 for an example embodiment of a power distribution management system that functions to provide power to corded tools while concurrently providing power to battery chargers. Power, suitably DC power, is supplied by generator scale battery 204. A generator-scale battery is a large-scale energy storage system designed to function alongside, or as an alternative to, traditional power generators. These batteries store substantial amounts of energy, allowing them to supply power for extended periods or deliver significant power output instantly on demand. They are typically used in backup power systems, grid stabilization, or hybrid configurations, where they can work with traditional generators to reduce fuel consumption and emissions by operating the generator only when necessary.

These batteries are characterized by their high energy capacity, scalability, and ability to handle frequent charging and discharging cycles. They are robust and suitable for industrial and large-scale applications. Generator-scale batteries are often used as backup power sources for critical systems such as hospitals, data centers, or manufacturing facilities. They can also support peak shaving, where energy is stored during off-peak times and used during peak demand to reduce electricity costs. In renewable energy setups, these batteries store energy from sources like solar or wind to provide power when generation is low or demand is high. Additionally, they are used for grid stabilization by absorbing excess energy when supply exceeds demand and discharging it when demand outpaces supply. In remote or off-grid areas, they store energy generated from renewable sources, reducing or eliminating the need for fossil-fuel generators.

Examples of generator-scale batteries include the Tesla Megapack, CAT Energy Storage systems, and Fluence Gridstack. These systems are often integrated with traditional generators to create hybrid setups, reducing emissions and fuel usage. They offer several advantages over traditional generators, including fuel-free operation, quiet and clean energy delivery, faster response times, and lower maintenance needs.

A generator-scale battery in the landscaping industry serves as a large-scale energy storage system that can power or supplement traditional generators used for landscaping equipment. These batteries are capable of storing and delivering substantial amounts of energy to operate high-demand tools like electric chainsaws, trimmers, blowers, and mowers. By providing reliable and portable power, they enable landscapers to work efficiently without relying entirely on gas or diesel-powered generators.

Landscapers can use generator-scale batteries to charge cordless tool batteries or directly power tools and machinery. For example, when operating in remote locations, a generator-scale battery can store energy from an on-site renewable source, such as portable solar panels, or be pre-charged for use in the field. These systems can prioritize active tools over idle or charging devices, ensuring that high-demand equipment like electric mowers or trimmers receive uninterrupted power while pausing lower-priority loads, such as chargers or less critical tools, during peak usage.

Generator-scale batteries are particularly beneficial for reducing noise and emissions in residential or noise-sensitive areas, where traditional gas generators may not be suitable. Their quiet operation allows landscapers to work without disturbing clients or violating local noise ordinances. Additionally, they offer instant power delivery, allowing landscapers to switch between devices seamlessly without the delays associated with starting and stopping a generator.

In hybrid setups, a generator-scale battery can be paired with a small generator to optimize fuel use. The generator can recharge the battery during downtime, while the battery provides primary power during operation. This reduces fuel costs and wear on the generator while maintaining a steady power supply for landscaping tools. Challenges include the higher upfront cost of the battery system and the need for careful load management to avoid depleting the stored energy prematurely.

DC power from generator scale battery 204 is fed to inverter 208. A DC power inverter converts direct current electricity, typically from sources like batteries, solar panels, or fuel cells, into alternating current (AC) electricity, which is the standard form of power used by most household appliances and electrical systems. The inverter enables the operation of AC-powered devices in environments where only DC power is available, such as in off-grid solar systems, vehicles, or portable power setups. It achieves this by using electronic circuits to modify the flow of DC electricity, creating a waveform that mimics the alternating nature of AC power, often at specific voltages and frequencies, for example 120V/60 Hz in the United States and 230V/50 Hz in Europe.

AC power from inverter 208 is fed to power management system (PMS) 212, into source controller 216. Source controller 216 manages and regulates a flow of power from inverter 208 to downstream components in PMS 212. It ensures that power is efficiently distributed to various connected devices, including current transformers, tools, and battery chargers, while preventing overloading or inefficiencies. Source controller 216 monitors an overall power demand and dynamically adjusts the allocation of energy to prioritize critical devices and balance loads. It suitably includes features for fault detection, overcurrent protection, and communication with other system controllers, such as other power distribution modules. Source controllers are commonly used in industrial, renewable energy, and portable power systems to optimize energy use and maintain safe, stable operation.

Source controller 216 feeds current transformer (CT) 220. CT 220 functions to measure circuit current and provide a scaled-down, proportional current signal to monitoring or protection equipment. CT 220 measures and monitors current flow to power tools 224, calculates power usage, and supplies data relative to detected faults or overloads and so as to trigger circuit breakers or control switches when needed. Alerts are suitably generated when one or more loads have been disconnected, such as by generating an alert, alarm or a visual indicator, such as a light, that indicates whether a particular outlet is enabled or disabled. It also provide electrical isolation between a high-current primary circuit and a low-current secondary circuit to ensure safety and compatibility for monitoring. By scaling high currents to manageable levels, current transformers enable accurate measurement, control, and protection in power systems. CT 220, in turn, provides power to one or more power tools.

Source controller 216 also feeds PDM controller 228 which provides power to one or more battery chargers 232 via a corresponding CT in a series of CTs 236 and corresponding controllable switches in a series of breakers 240, which are configured to cooperatively calculate available current and set a threshold current in the PDM controller accordingly. This functions to keep a total current below a current limit of inverter 208.

Controllable switches suitably used to connect or disconnect specific loads, such as battery chargers or power tools, are based on system requirements. The type of switch used depends on factors like voltage, current, response time, and efficiency. Electromechanical relays are one option, operated by an electromagnetic coil and capable of handling high currents, but they have slower response times and are prone to wear over time due to their moving parts. Solid-state relays use semiconductors instead of mechanical components, offering faster response times and longer lifespans, which makes them ideal for applications requiring frequent switching. MOSFETs provide high-speed, low-loss switching for DC circuits, with excellent efficiency and suitability for battery management systems. For higher-voltage or higher-current applications, IGBTs are often chosen because they combine the fast switching characteristics of MOSFETs with the power-handling capabilities of bipolar transistors. Thyristors and triacs are commonly used for controlling AC power, with thyristors handling high-current loads and triacs enabling bidirectional power control, making them suitable for managing AC loads like battery chargers. Relay modules with built-in control circuits are suitable, simplifying integration with microcontrollers or other components. Advanced smart switches or circuit breakers, which incorporate monitoring and communication features, are suitable for such intelligent power management systems.

Non-critical systems, such as battery charges, can be reconnected as power consumption drifts below the threshold value. Outlets can be reconnected based on historical levels of power consumed by that outlet relative to how much capacity is regained relative to the threshold value. By way of example, if 4 amps become available below a current threshold value, one or more outlets that drew an aggregate of 4 amps prior to cutoff can be restored.

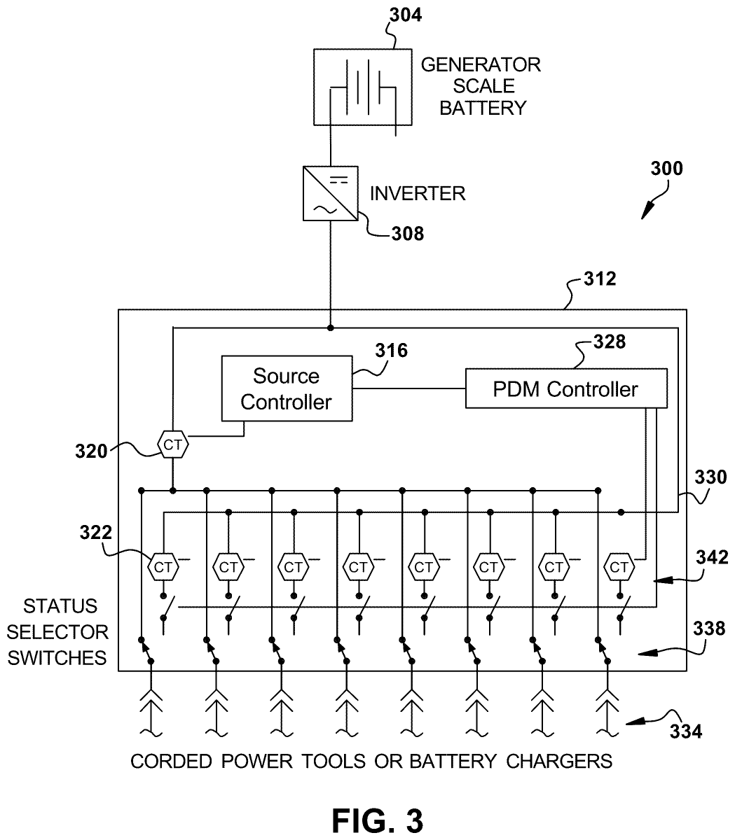

FIG. 3 illustrates a circuit diagram 300 for an example embodiment of a power distribution management system that functions to selectively provide power to either power tools or battery chargers. In this example embodiment, any outlet can accommodate a power tool or a battery charger, and a selector switch is engaged for each outlet to specify which one is present. Generator scale battery 304 feeds DC power to inverter 308, which in turn feeds AC power to PDM control module 312 into source controller 316. Source controller 316 supplies power to CT 320 which, in turn, supplies power to corded power tool supply line 322.

Source controller 316 also supplies power to PDM controller 328 which, in turn, supplies power to battery charger supply line 330. Each device supply line or outlet 334 is fed by one of a series of controllable selector switches 338 that specify whether an associated outlet is to be fed from power tool supply line 322 or battery charger supply line 330. When a battery charger is selected, connection to each charge is via one of an associated series of CTs 342. Accordingly, source controller 316 communicates available current updates based on always on (power tool) outlets to PDM controller 328. PDM controller 328 relays battery charger status lines to on or off to keep a total current below a threshold limit associated with inverter 308.

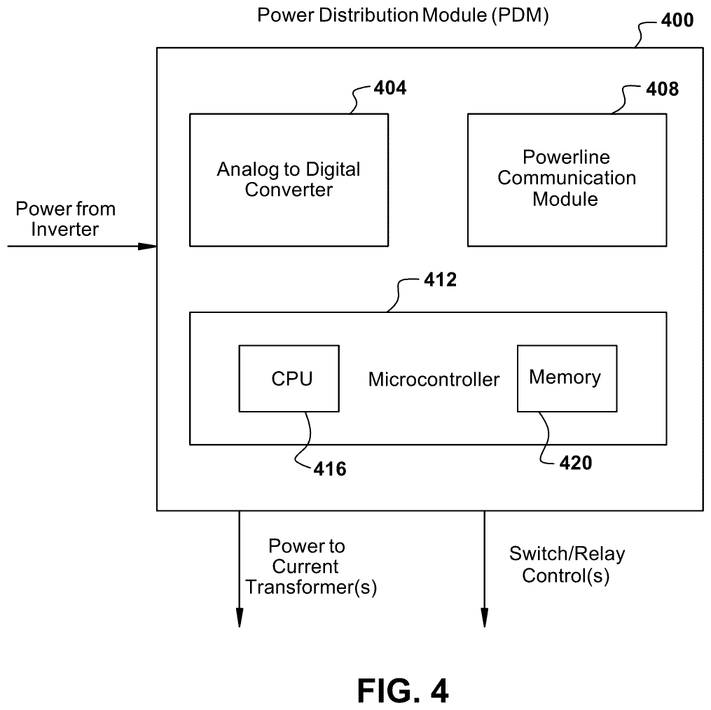

FIG. 4 illustrates an example embodiment of a PDM controller 400. Included is an analog to digital converter 404, powerline communications module 408 and microcontroller 412. Microcontroller 412 includes one or more CPUs, such as CPU 416 and volatile or non-volatile data storage, illustrated by memory 420.

PDM controller 400 provides efficient energy allocation monitors power from an inverter and ensures uninterrupted power supply to essential devices like power tools, while dynamically managing interruptible power for battery chargers. The system includes analog-to-digital converter (ADC) 404 to measure and digitize electrical signals, enabling precise monitoring of current and voltage levels across the system. Powerline communication module 408 functions to provide communication between an inverter, controllers, and connected devices over the powerline infrastructure, reducing the need for separate communication wiring. The microcontroller serves as the central processor, coordinating real-time decisions based on data collected from the ADC and other sensors.

In operation the system continuously monitors the total current being drawn from the inverter and the current consumed by each battery charger line. When the overall current approaches the inverter's set threshold, the microcontroller identifies which battery chargers can be temporarily disconnected without impacting critical operations. Using this prioritization, the system selectively disconnects chargers to keep the total current below the threshold, ensuring stable operation of power tools and other high-priority devices. Once the load decreases, the microcontroller selectively reconnects the chargers based on their demand and availability.

Operation of the PDM controller in the example embodiment dynamically adjusts individual power outlets based on both shared and individual current measurements to ensure that the total power consumption remains within acceptable limits. This code is written in Arduino's open source variant of C/C++. Arduino programming language is based on C/C++ and provides a simplified interface for working with hardware. It utilizes C/C++ syntax along with additional libraries and functions specific to the Arduino platform. The example code dynamically adjusts individual power outlets based on both shared and individual current measurements to ensure that the total power consumption remains within acceptable limits follows:

```
  const int numOutlets = 4; // Number of outlets
  const int sharedCurrentPin = A0; // Analog pin connected to the shared current sensor
  const int individualCurrentPin[numOutlets] = {A1, A2, A3, A4}; // Analog pins connected
to individual current sensors
  const int relayPin[numOutlets] = {2, 3, 4, 5}; // Digital pins connected to SSRs
  const float initialThreshold = 20.0; // Initial total power threshold in amps
  const float sharedThreshold = 15.0; // Threshold for shared current
  float individualThreshold = initialThreshold / numOutlets; // Threshold for individual
outlets
  void setup( ) {
    // Initialize serial communication
    Serial.begin(9600);
    // Set relay pins as outputs
    for (int i = 0; i < numOutlets; i++) {
    pinMode(relayPin[i], OUTPUT);
    digitalWrite(relayPin[i], HIGH); // Initially turn on all relays
    }
  }
  void loop( ) {
    float sharedCurrent = readSharedCurrent( );
    float individualCurrent[numOutlets];
    float remainingThreshold = initialThreshold;
    // Read individual current from each outlet
    for (int i = 0; i < numOutlets; i++) {
    individualCurrent[i] = readIndividualCurrent(i);
    }
    // Calculate remaining available power after considering individual currents
    for (int i = 0; i < numOutlets; i++) {
    if (individualCurrent[i] > individualThreshold) {
      remainingThreshold −= individualCurrent[i];
    }
    }
    // Check if shared current exceeds the threshold
    if (sharedCurrent > sharedThreshold) {
    // Determine which outlets need to be disabled
    for (int i = 0; i < numOutlets; i++) {
      if (individualCurrent[i] > individualThreshold) {
      digitalWrite(relayPin[i], LOW); // Turn off relay for this outlet
      } else {
      digitalWrite(relayPin[i], HIGH); // Turn on relay for this outlet
      }
    }
    Serial.println(“Shared current threshold exceeded. Adjusting outlets.”);
    } else {
    // Re-enable outlets up to the extent of remaining available power
    for (int i = 0; i < numOutlets; i++) {
      if (remainingThreshold > individualThreshold) {
      digitalWrite(relayPin[i], HIGH); // Turn on relay for this outlet
      remainingThreshold −= individualThreshold;
      } else {
      digitalWrite(relayPin[i], LOW); // Turn off relay for this outlet
      }
    }
    Serial.println(“Shared current within threshold. Adjusting outlets.”);
    }
    delay(1000); // Delay before next loop iteration
  }
  float readSharedCurrent( ) {
    // Read analog value from shared current sensor
    int sensorValue = analogRead(sharedCurrentPin);
    // Convert analog value to current (adjust as per sensor calibration)
    float sharedCurrent = map(sensorValue, 0, 1023, 0, 20); // Assuming 0-20 amps range
    return sharedCurrent;
  }
  float readIndividualCurrent(int outletIndex) {
    // Read analog value from individual current sensor for the specified outlet
    int sensorValue = analogRead(individualCurrentPin[outletIndex]);
    // Convert analog value to current (adjust as per sensor calibration)
    float individualCurrent = map(sensorValue, 0, 1023, 0, 20); // Assuming 0-20 amps range
    return individualCurrent;
  }
```

This example code is suitable a microcontroller-based power management system that dynamically adjusts individual power outlets based on both shared and individual current measurements, while considering the available power remaining. The example code operates as follows:

It defines constants for the number of outlets (numOutlets), analog pins connected to a shared current sensor (sharedCurrentPin), analog pins connected to individual current sensors (individualCurrentPin), digital pins connected to solid-state relays (relayPin), initial total power threshold (initialThreshold), threshold for shared current (sharedThreshold), and calculates the threshold for individual outlets based on the initial threshold and number of outlets (individualThreshold).

In the setup( ) function:
It initializes serial communication for debugging purposes.
It sets the relay pins as outputs and initially turns on all relays.

In the loop( ) function:
It reads the shared current from the shared current sensor using the readSharedCurrent( ) function.
It reads individual currents from each outlet using the readIndividualCurrent( ) function.
It calculates the remaining available power after considering individual currents.
It checks if the shared current exceeds the threshold.
If the shared current exceeds the threshold, it individually checks each outlet's current consumption against the calculated individual threshold and disables the outlets accordingly.
If the shared current is within the threshold, it re-enables outlets up to the extent of the remaining available power.
It then delays for one second before the next iteration of the loop.

There are two helper functions:
readSharedCurrent( ): Reads the analog value from the shared current sensor and converts it to a current value.
readIndividualCurrent(int outletIndex): Reads the analog value from the individual current sensor for a specific outlet and converts it to a current value.

In summary, this code creates a power management system that dynamically adjusts individual power outlets based on shared and individual current measurements while considering the available power remaining, ensuring that the total power consumption remains within acceptable limits.

It will thus be seen that the objects set forth above, among those made apparent from the preceding description, are efficiently attained, and since certain changes may be made in the constructions set forth without departing from the spirit and scope of the disclosure, it is intended that all matter contained in the above description and shown in the accompanying drawings shall be interpreted as illustrative and not in a limiting sense. The disclosure has been described with reference to preferred and alternate embodiments. Modifications and alterations will become apparent to those skilled in the art upon reading and understanding the detailed discussion of the disclosure provided herein. This disclosure is intended to include all such modifications and alterations insofar as they come within the scope of the present disclosure. It is also to be understood that the following claims are intended to cover all of the generic and specific features of the disclosure herein described and all statements of the scope of the disclosure, which, as a matter of language, might be said to fall therebetween.

To aid the Patent Office and any readers of this application and any resulting patent in interpreting the claims appended hereto, applicants do not intend any of the appended claims or claim elements to invoke 35 U.S.C. 112(f) unless the words “means for” or “step for” are explicitly used in the particular claim.

What is claimed:

1. A power distribution management system comprising:
a first set of one or more power outlets on a power distribution circuit; said power distribution circuit includes a circuit power monitor that is configured to monitor power used by said circuit;
a second set of one or more power outlets on said power distribution circuit; each circuit of said second set includes an associated outlet power monitor that is configured to monitor power to an associated power outlet; and
a controller that is configured to selectively disable power to one or more power outlets in the second set when power monitored by said circuit power monitor achieves a threshold value.

2. The power distribution system as defined in claim 1, wherein each outlet includes a selector switch designating its associated outlet as being in said first set or second set of power outlets.

3. The power distribution system as defined in claim 1, wherein one or more of said circuit power monitor and said outlet power monitor is comprised of a current transformer.

4. The power distribution system as defined in claim 1, wherein one or more devices powered by said first set of power outlets comprise critical devices.

5. The power distribution system as defined in claim 4, wherein said one or more devices powered by said second set of power outlets comprise battery chargers.

6. The power distribution system as defined in claim 1, wherein said controller is further configured to selectively enable power to said one or more power outlets in said second set of power outlets when said power monitored by said circuit power monitor falls below said threshold value.

7. The power distribution system as defined in claim 6, wherein said controller is further configured to selectively enable power to said one more power outlets in said second set based on associated amount of power used prior to disabling.

8. A method for managing power distribution comprising:
supplying power from an inverter to a plurality of connected devices;
measuring current to each device using a plurality of current transformers;
monitoring total current draw using a microcontroller;
prioritizing power delivery to critical devices;
and selectively disconnecting non-critical devices when said total current exceeds a predefined threshold.

9. The method as defined in claim 8, further comprising reconnecting non-critical devices when said total current drops below said predefined threshold.

10. The method as defined in claim 8, wherein measuring current comprises using an analog-to-digital converter to convert analog signals from said current transformers into digital data.

11. The method as defined in claim 8, further comprising transmitting and receiving data over a powerline communications module to coordinate power distribution.

12. The method as defined in claim 8, wherein prioritizing power delivery involves identifying critical devices that require continuous operation and non-critical devices that can tolerate interruptions.

13. The method as defined in claim 8, further comprising analyzing power usage data stored by said microcontroller to optimize load management.

14. The method as defined in claim 8, wherein selectively disconnecting non-critical devices includes using controllable switches coupled to said current transformers.

15. A computer program product for managing power distribution; said computer program comprises non-transitory computer-readable instructions, when executed by a processor, cause said processor to:
receive current measurements from a plurality of current transformers;
calculate total current draw;
compare said total current draw to a predefined threshold;
and selectively disconnect or reconnect devices based on said comparison.

16. The computer program product as defined in claim 15, wherein said instructions further cause said processor to prioritize power delivery to critical devices and limit power to non-critical devices.

17. The computer program product as defined in claim 15, wherein said instructions include transmitting and receiving power management data over a powerline communications module.

18. The computer program product as defined in claim 15, wherein said instructions further cause said processor to store historical power usage data for later analysis.

19. The computer program product as defined in claim 15, wherein said instructions include generating real-time alerts when said total current draw approaches said predefined threshold.

20. The computer program product as defined in claim 15, wherein said instructions configure controllable switches to disconnect or reconnect specific devices based on said calculated current draw.
